(19) United States
(12) Patent Application Publication
(10) Pub. No.: US 2002/0189497 A1
(43) Pub. Date: Dec. 19, 2002

(54) Method of reducing carbon levels in fly ash

(75) Inventor: James M. Tranquilla, Fredericton (CA)

Correspondence Address: BRINKS HOFER GILSON & LIONE, P. O. Box 10395, Chicago, IL, 60610, US

(73) Assignee: EMR Microwave Technology Corporation

(21) Appl. No.: 09/872,178

(22) Filed: Jun. 1, 2001

(51) Int. Cl. C04B 18/04; C04B 18/06

(52) U.S. Cl. 106/405; 106/705

(57) ABSTRACT

There is disclosed a method of reducing carbon levels in fly ash. The method comprises the steps of: (a) placing the fly ash in a microwave reactor; (b) exposing said fly ash to microwave radiation in the presence of carbon-free material so as to raise its temperature to at least 600° C. while agitating the fly ash in the presence of oxygen; and; (c) terminating exposure of said fly ash to said microwave radiation when the carbon content of the fly ash has fallen below a predetermined value.

### FIELD OF THE INVENTION

This invention relates to a method of reducing carbon levels from the combustion products of incompletely combusted fossil fuels and, more particularly to a microwave process for reducing carbon levels in fly ash.

### BACKGROUND OF THE INVENTION

Coal combustion is one of the oldest industrial processes which is still widely practiced today. Aside from environmental issues related to combustion of fossil fuels, the efficient use of such fuels, for example coal, depends on nearly complete oxidation of the carbon. The high combustion system operating temperatures that are employed (in the range of 3000° C.) often lead to the formation of nitrous oxides. Current environmental emission restrictions on nitrous oxide generation have lead to a reduction in the operating temperatures of fossil fuel combustion systems, resulting in incomplete burning of the carbon (loss on ignition, “LOI”) and transmission of this carbon through the stack gas to the gas filters and finally into fly ash (As used herein the term “fly ash” refers to a carbon-containing by-product of the incomplete combustion of a fossil fuel).

Fly ash is commonly used as a cement additive; however, high carbon content in fly ash substantially reduces its commercial value as an additive. For example, reduction of the LOI (carbon content) from approximately 10% to 3% in fly ash results in a value increase of to 2 to 3 fold. Therefore, a means of substantially reducing or eliminating the LOI is of significant economic value.

One method employed to reduce the residual carbon content of fly ash is to roast the fly ash in the presence of an auxiliary fuel, usually petroleum or natural gas, and combust the mixture. This method has the disadvantage of producing additional combustion by-products which are themselves the subject of environmental concern.

Other proposed methods of treating carbonized fly-ash are known, including: mechanical and pneumatic classification, flotation or frothing, electrostatic classification and burnout through the addition of auxiliary fuel. Such processes may result in a segregated carbon-rich stream which must then be combusted under conditions which are identical or similar to those of primary combustion which will generally lead to NOₓ generation. This may aggravate the environmental situation which caused the selection of a primary combustion method producing unburned carbon in the first place.

Typical methods of treating NOₓ necessitate scrubbing the gas stream to remove NOₓ products using various converters which inject ammonia into the hot gas stream, chemically reducing the nitrous oxides and forming simple nitrogen gas and water. The combination of ammonia with the flue gas products is not entirely efficient, resulting in some ammonia adsorbing to the ash in the form of ammonia salts, a condition known in the industry as ammonia slip.

Once in the ash, the ammonia salts (usually in the form of ammonium sulfate) will generally decompose with time and in the presence of moisture to release ammonia gas. Since one of the major uses of fly ash is as a cement additive, the release of ammonia gas at cement construction sites is a significant personnel health hazard as well as an environmental contaminant.

Currently available ammonia removal technologies rely principally on the thermal removal of ammonia from the ash. This is commonly carried out simultaneously with the ash incineration used to combust (burnout) the unburned carbon in the ash. None of the current processes for ammonia removal are completely acceptable in terms of performance or cost. There remains, therefore, a need for an effective means of removing adsorbed ammonia from fly ash.

If the production of a carbon-enriched ash stream is not followed by recombustion, then the material must be otherwise disposed, usually in landfill which is becoming increasingly costly and environmentally difficult.

It is therefore desirable to have a method of reducing carbon levels in fly ash of broadly ranging LOI while minimizing undesirable combustion by-products.

### BRIEF DESCRIPTION OF THE PRIOR ART

Crawford and Curran (U.K. Patent 1,092,861) disclose a method for heating coal whereby the volatile products are liberated. Connell and Moe (U.S. Pat. No. 3,261,959) teach a method for applying microwave energy to iron ores in order to oxidize the product and further teach that this process may require the addition of water to increase the microwave receptivity of the materials being processed. Jukkola (U.S. Pat. No. 3,632,312) discloses a method for roasting sulphide ores in order to produce an enriched SO₂ gas product. Kruesi (U.S. Pat. Nos. 4,311,520, 4,321,089, 4,324,582) further teaches processes whereby microwave energy may be used to treat several ores for the recovery of copper, nickel, cobalt, manganese, molybdenum, rhenium and other metals. In each of these cases, the microwave energy is used to generate heat in the mineral resulting in a chemical reaction which produces an intermediate product ready for subsequent metal recovery. Beeby (PCT WO 92/18249) discloses a process utilizing pulsed microwave energy which results in increased metal leachability from ores due to either oxidation or thermally induced microfracturing.

U.S. Pat. Nos. 5,160,539 and 5,399,194 disclose the use of a dry, bubbling bed comprising a mixture of fly ash and partially combusted ash wherein the apparatus is maintained at oxidizing temperature sufficient to ignite the carbon.

U.S. Pat. No. 5,160,539 of Cochran discloses a method of reducing carbon content in fly ash using a fluidized bed reactor wherein the fluidized bed is essentially free of any material other than carbon-containing fly ash. The use of a fluidized bed consisting essentially of carbon-containing fly ash may cause “clinkering” and fusing of the fly ash resulting from localized overheating. This can reduce the efficiency of the carbon-reduction process and lead to the production of a less desirable carbon-depleted product.

U.S. Pat. No. 5,161,471 of Piekos discloses the use of a bubbling bed of burning ash material wherein both underfire and overfire combustion air is introduced. U.S. Pat No. 5,390,611 of John describes a process in which fly ash is electrically preheated and combusted while being tumbled to effect good oxygen-solids contacts. U.S. Pat. No. 5,484,476 of Boyd describes a method for preheating fly ash prior to its being injected into a combustion vessel.

U.S. Pat. No. 4,663,507 of Trerice discloses a method for using microwave energy at approximately 2450 MHz in an elongated waveguide apparatus for both oxidizing the carbon from fly ash and for measuring the residual carbon content therein. His disclosure of the selective absorption characteristics of the carbon constituent in fly ash is well known, being the basis of selective heating of a wide range of admixtures, including mineral substances, and is well understood by those knowledgeable in the art of microwave processing.

Although the Trerice patent discloses the use of 2450 MHz microwave energy for the oxidation of carbon in fly ash, there remains a need for a more optimal and effective means for mixing, agitating, controlling and transporting the fly ash being processed in order to avoid uncontrolled, localized heating and clinkering of the fly ash. The phenomenon of highly localized overheating of microwave receptive materials is well known, often referred to as thermal runaway, leading to a generally uncontrolled process which, in the case of minerals and similar materials, usually leads to a clinkering and fusing of the material. This is particularly the case for very highly absorptive materials such as carbon in the presence of silicates (which easily fuse into glass) and iron compounds (which fuse into various iron oxides such as magnetite and hematite). The difficulty is greatly exacerbated when the material being processed contains sufficient fuel value that it is capable of autothermal reaction, i.e. the oxidation reaction, once initiated, is sustained by the heat released from the burning fuel.

The Trerice patent is susceptible to the problems of clinkering and thermal runaway. In particular, desirable reaction control requires a continuous, intimate mixing of oxygen and fly ash, which is not taught by Trerice.

It is therefore an object of the present invention to provide an improved method of reducing carbon levels in a material to be processed, utilizing microwave radiation.

### SUMMARY OF THE INVENTION

The invention comprises a method of reducing carbon levels in fly ash comprising the steps of:

(a) placing the fly ash in a microwave reactor;

(b) exposing said fly ash to microwave radiation in the presence of carbon-free material so as to raise its temperature to at least 600° C. while agitating the fly ash in the presence of oxygen; and

(c) terminating exposure of said fly ash to said microwave radiation when the carbon content has fallen below a predetermined level.

### BRIEF DESCRIPTION OF THE DRAWING

FIG. 1 is a perspective view of an apparatus for carrying out an embodiment of the method of the present invention, shown in partial cut-away.

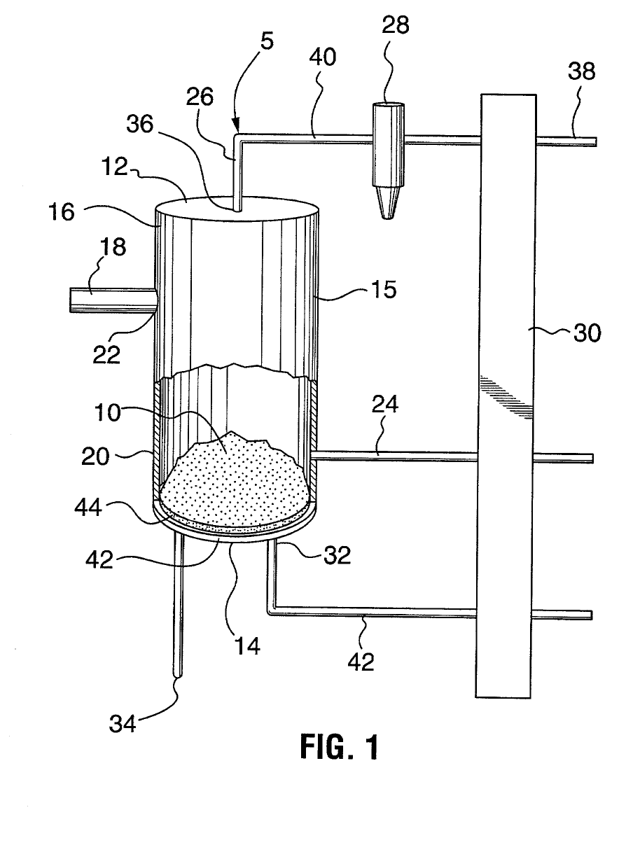

### DETAILED DESCRIPTION OF THE PREFERRED EMBODIMENTS

In an embodiment of the present invention, fly ash is processed in a microwave reactor 5. The microwave reactor 5 preferably comprises a chamber 15, a microwave input 18, a vent 26 and an oxygen input 34. The chamber 15 preferably includes a top 12 and a bottom 14 fixedly sealed to a wall 16, said top 12, bottom 14 and wall 16 preferably comprising microwave impenetrable material. The oxygen input 34 is preferably a source of atmospheric air and may be a conduit having a first end in communication with the chamber and a second end open to the exterior environment such that atmospheric air passes through the conduit and into the chamber as required for combustion. In one embodiment of the invention, the microwave reactor 5 further includes a fluidized bed, which facilitates continuous intimate mixing of air and fly ash.

The vent 26 preferably has an uptake end 36 and a discharge end 38 and a vent tube 40 connecting said uptake end 36 and side discharge end 38. The uptake end 36 of the vent 26 is preferably in communication with the upper portion of the interior of the microwave reactor 5, such that gaseous products of the microwave treatment of the fly ash 10 will enter the uptake end. The vent 26 preferably further comprises a filter 28 located along the vent tube 40 and adapted to remove dust, solids and residues from the gaseous material passing through the vent tube 40. The vent 26 preferably further includes a heat exchanger 30 adapted to facilitate the transfer of heat from the gaseous material to fly ash 10 entering the microwave reactor 5.

The microwave reactor 5 preferably further includes a fluidized reactor bed 42 adapted to receive the fly ash 10. Underlying and in contact with the fly ash is a secondary “host” bed of substantially carbon-free material 44. The material comprising the host bed 44 is preferably selected to be coarser than the fly ash and so remains relatively static generally near the bottom of the reactor vessel whereas the lighter fly ash is more highly fluidized. Fly ash introduced into the reactor vessel 5 is caused to pass through and intermix with the host bed material during processing.

The carbon-free material 44 will be suitably selected from any heat-stable material which is substantially free of carbon, does not chemically react significantly with fly ash 10 or its process products during microwave exposure and can be conveniently mixed with the fly ash during processing. The type of carbon-free material employed may be selected based on the carbon content of the fly ash to be treated. The type of carbon-free material may be varied during processing as the characteristics of the fly ash treated and the overall reaction temperature vary. For example, where the fly ash to be treated has a low LOI (for example, below 5-8%) carbon depletion can be initiated more rapidly by employing a carbon-free material which is a good microwave receptor at its temperature in the fluidized bed. Where the fluidized bed, including the carbon-free material, is at about 20° C., manganese dioxide is a suitable carbon-free material where rapid initiation of the carbon-depletion process is desired.

Other types of carbon-free materials will be suitable at various reaction temperatures. For example, silica is a good microwave receptor at 800° C. and is a preferred carbon-free material used in the fluidized bed when carbon depletion is occurring. It will be appreciated that the method of the present invention can be carried out using a variety of suitable carbon-free materials. Specifically, low microwave receptivity of a carbon-free material can be compensated for by longer heating and mixing of the fly ash, whereas use of carbon-free material having high microwave receptivity can allow for shorter processing times.

The use of a suitable carbon-free material provides improved heating uniformity and reduces clinkering, fusing of materials, and auto thermal runaway. The carbon-free material can also act to grind fused material by mixing.

The substantial lack of carbon in the carbon-free material is important to avoid having the material react during microwave exposure, which could lead to clinkering, fusing, and auto thermal runaway.

Preferably, carbon-free material is mixed with fly ash at a ratio of between about 75 parts carbon-free material to 25 parts fly ash, and about 25 parts carbon-free material to 75 parts fly ash. The precise ratio of carbon-free material to fly ash can be varied, depending on the carbon content of the fly ash and the carbon-free material employed, in order to provide satisfactory heating uniformity.

The quantity of fly ash present in the microwave reactor may be determined by methods known in the art, in light of the disclosure herein, with reference to the size of the microwave reactor, the microwave power to be applied and the mineral composition of the fly ash. The quantity of fly ash present in the microwave reactor is preferably that quantity which can be heated in a substantially uniform manner, taking into consideration the agitation and mixing action of the fluidizing gas stream. Preferably, the fly ash contains at least 3% carbon by weight prior to microwave exposure. There is no allowable upper limit to carbon composition. The method of the present invention permits carbon depletion of fly ash to levels below 3% by weight and preferably within the range of 2±0.5% by weight. The method of the present invention permits fly ash to be carbon depleted without the need for the addition of an auxiliary fuel and without the production of significant nitrogen oxide gaseous byproducts.

The microwave radiation employed in the treatment of the fly ash may be selected from any frequencies within the microwave range of 300 MHz to 3000 MHz. Preferably, the microwave radiation employed has an average frequency of either approximately 915 MHz or approximately 2450 MHz. The use of microwave radiation having a frequency of 915 MHz or 2450 MHz is desirable because commercial microwave generating equipment is readily available in these frequency ranges. Any convenient microwave incident power may be employed in treating the fly ash, provided that the specific energy is appropriate to the volume and condition of the fly ash to be treated. In a preferred embodiment, a microwave power level and process duration time are employed which are sufficient to cause the temperature in the fly ash to rise above 600° C. and to impart a specific energy in the fly ash of between 2 kW-h/t and 25 kW-h/t. In another preferred embodiment, a specific energy of between 5 kW-h/t and 10 kW-h/t is imparted to the fly ash. It will be apparent to one skilled in the art that the microwave power level and process duration time necessary to produce a desired specific energy in the fly ash may be readily determined, in light of the disclosure herein and standard procedures in the field.

It is desirable to monitor the temperature of the fly ash during its exposure to microwave radiation, in order to assess the stage of the process. In particular, in batch processes it will sometimes be desirable to know when the fly ash temperature has increased to over 600° C. and subsequently decreased below 600° C. as this can indicate that the carbon content of the fly ash in the batch process has fallen below a predetermined level. Methods and systems for monitoring the temperature of a material during microwave radiation exposure are known in the art. Preferably, the temperature is continuously monitored using an infra-red pyrometer, or by way of thermocouplers embedded in the walls of the reactor vessel.

In a preferred embodiment, the fly ash is exposed to microwave radiation in a batch mode of operation until the fly ash temperature has exceeded 600° C. and has commenced a decrease in temperature. In one embodiment, the fly ash is exposed to microwave radiation until it has exceeded 600° C. in temperature, and has subsequently declined in temperature below 600° C. In another embodiment, the fly ash is exposed to microwave radiation until it has exceeded 600° C. in temperature, and subsequently declined in temperature to a temperature of no more than 550° C. Once the fly ash has decreased in temperature to the desired temperature, exposure to microwave radiation is preferably terminated.

In another preferred embodiment the treatment of fly ash is conducted in an on-going flow-type system. The microwave reactor 5 may further include a material feed system 24 to introduce fresh (non-microwave exposed) fly ash, and a removal system 32 to remove calcine (fly ash which has been exposed to microwave radiation having a carbon content of below 3% by weight). The removal system 32 removes calcine from the microwave reactor 5. The material feed system 24 adds fresh fly ash to the microwave reactor to replace calcine removed by the removal system 32, thereby allowing an ongoing flow-type process. In this preferred embodiment, fly ash is fed into the microwave reactor 5 by the material feed system 24 at a rate determined in light of the time required for the fly ash to achieve a temperature of between 600° C.-850° C. and remain at this temperature for a prescribed average duration, at which point it is removed from the microwave reactor by the removal system 32. It will be apparent to one skilled in the art that the time required for fly ash to achieve 600° C.-850° C. and the magnitude of the prescribed average duration can be readily determined with reference to the prior art and the material herein disclosed, and in light of the microwave frequency, microwave incident power, microwave reactor configuration, the quantity of fly ash introduced at a given time, and the correlation between the treatment temperature and the fly ash depletion rate. In one embodiment, fly ash is monitored for carbon content during the treatment process and fly ash is removed by the removal system when carbon content of the fly ash has fallen below a predetermined level, which may be 3% or more or less than 3%.

The removal system 32 preferably comprises a discharge tube 42 located at the bottom 14 of the microwave reactor 5, and adapted to carry calcine from the microwave reactor 5 to a calcine collection vessel. In a particularly preferred embodiment, the removal system further includes a heat exchanger adapted to facilitate the transfer the heat from the calcine to fly ash prior to the entry of that fly ash into the microwave reactor.

In one commercial scale application of an embodiment of the method of the present invention, 35 lbs of fly ash was processed in a microwave reactor under steady state operating conditions for 45 minutes at a reaction bed temperature of 800° C. A specific energy of between 15 and 20 kW-h/t (based on metered AC power consumption and actual fly ash produced) was employed. In this instance, initial fly ash carbon content was 13% and the carbon content of the resultant fly ash was below 3%.

The method of the present invention is also useful in depleting ammonia from fly ash. While the method will typically be carried out on fly ash containing both carbon and ammonia, the method is also useful in treating samples containing only one of these two materials.

Fly ash can be efficiently heated using microwave energy due to the residual carbon content in the ash and/or the microwave heating of a secondary bed material. Using the carbon or secondary bed material as a microwave receptor, the fly ash can be heated to a temperature sufficient to combust the carbon in the presence of air (a process known as carbon burnout). At these temperatures, in the range of 600° C.-900° C., the ammonia compounds are chemically decomposed with the resultant ammonia gas passing off in the gas stream. A temperature of 350° C. is adequate for ammonia depletion and samples containing ammonia can be heated to this temperature for treatment even where the sample contains little or no carbon.

In an embodiment of the present invention, fly ash is heated in a fluidized bed chamber into which microwave energy is introduced. Atmospheric air is used as the fluidizing gas. The temperature of the ash is maintained in the range 600° C.-900° C. which is sufficient to cause the residual carbon to combust and to cause the reduction of ammonia products. For reasons which are not yet completely understood, possibly due to the close affinity between the ammonia compounds and the carbon particles acting as adsorbing surfaces, the use of the disclosed microwave burnout process is more effective in eliminating ammonia compounds than are conventional thermal burnout techniques.

### EXAMPLES

### Example 1

A sample of 991.2 grams of fly ash, sieved to greater than 106 microns, was heated in a microwave reactor into which atmospheric air was introduced to supply oxygen for carbon combustion. For this experiment, a microwave incident power of between 10 and 15 kW was used. Carbon content of the fly ash sample was measured by LECO™ combustion analysis to be 25.2% organic carbon. Microwave power was applied for approximately 30 minutes. The temperature of the fly ash was continuously monitored using an infra-red pyrometer.

The fly ash material was observed to heat very rapidly in response to the application of microwave power. Peak temperatures exceeding 600° C. were reached. The material was observed to glow brightly for a short period and then to spontaneously cool down due to carbon depletion. Since carbon is the principle microwave receptive component of the fly ash, the depletion of carbon results in a substantially microwave “transparent” material which is a poor microwave receptor.

The microwave reactor employed in this experiment is a type of fluidized bed in which air is pumped through the material to be reacted (fly ash). Very fine material (less than 106 microns) tends to be blown out of the reactor vessel and is captured in a filter installed in the vent.

Samples collected through this experiment included:

1. Unprocessed fly ash, designated “head” material in Table 1;

2. Processed fly ash, designated “experiment calcine” material, remaining in the reactor in the completion of the experiment;

3. Partially processed fly ash, designated “grab” material, which was extracted from the reactor before completion of the combustion process;

4. Processed fly ash, designated “light calcine” which was extracted from the reactor after completion of the combustion process, but before disassembly of the reactor such that the sample did not contain material (possibly not fully combusted) dislodged from the inner lining of the reactor;

5. Essentially unprocessed fly ash, designated “filter” material, which was collected from the filter and which represented material blown out of the reactor prior to combustion.

All samples except the “head” sample were tested for carbon content by roasting in air in a electric furnace and measuring weight loss. As previously discussed, “head” material was assessed for carbon content using LECO™ combustion analysis according to standard methods. The results of these analysis is depicted in Table 1. A detailed chemical and mineralogical analysis of “head” material is disclosed in Table 2. Each of the processed materials “(calcine, light calcine, grab) shows a very high degree of carbon depletion, in each case well below 3% carbon content by weight (LOI), and in the case of Experiment calcine, below 2% carbon content by weight.

TABLE 1

| | | | | Mass of |
|---|---|---|---|---|
| | Sample | % Carbon | Mass (g) | Carbon (g) |
| Input | Head | 25.2 | 991.2 | 249.782 |
| Output | Calcine | 1.3 | 74.6 | 0.955 |
| | Light Calcine | 0.2 | 9.9 | 0.018 |
| | Grab | 1.9 | 2.4 | 0.045 |
| | Filter | 25.4 | 826.6 | 209.874 |
| Loss | — | — | 77.7 | 38.891 |

### Example 2

A sample of fly ash from a coal generating station was selected for continuous microwave processing using a fluidized bed reactor vessel with atmospheric air as the fluidizing oxygen input. The fly ash was analyzed for size distribution with 50% passing 20μ.

Fly ash was fed to (and discharged from) the reactor vessel at the rate of 1.5 lb/min and microwave power was adjusted to maintain a measured bed temperature of 800° C.-850° C. The test was continued at steady state conditions for at least 130 minutes during which substantially all discharge material was collected. The initial ash LOI was measured to be 9%. A total of 13 processed ash samples were analyzed yielding an average LOI of 2.7%.

### Example 3

A sample of fly ash was processed as described in Experiment 2 using a feed (and discharge) rate of 1.4 lb/min and a bed temperature of 825° C. The initial ash LOI was 9%; a total of 10 processed ash samples was analyzed yielding average LOI of 0.6%.

### Example 4

A sample of fly ash from a coal generating station was selected for continuous microwave processing using a fluidized bed reactor with atmospheric air as the fluidizing oxygen input. The ash was analyzed for size distribution with 50% passing 20 microns.

A host bed material consisting of coarsely ground manganese dioxide was heated by microwave radiation while being fluidized. Once the bed temperature had reached 600° C., fly ash was fed to (and discharged from) the reactor vessel at the rate of 1.5 lb/min and microwave power was adjusted to maintain a measured bed temperature of 800° C.-850° C. The test was continued at steady state conditions for at least 130 minutes during which substantially all discharge material was collected. The initial ash LOI was measured to be 9% with an ammonia concentration of 770 ppm. A total of 13 processed ash samples was analyzed yielding an average LOI of 2.7% and an average ammonia concentration of 2.98 ppm.

### Example 5

A sample fly ash was processed as described in Experiment 4 using a feed (and discharge) rate of 1.4 lb/min and a bed temperature of 825° C. The initial ash LOI was 9% with an ammonia concentration of 770 ppm; a total of 10 processed ash samples was analyzed yielding average LOI of 0.6% and an average ammonia concentration of 3.14 ppm.

The embodiments of the invention in which an exclusive property or privilege is claimed are defined as follows: what I/we claim as my/our invention:

1. A method of reducing carbon levels in fly ash comprising:
(a) placing the fly ash in a microwave reactor;
(b) exposing the fly ash to microwave radiation in the presence of carbon-free material so as to raise the fly ash temperature to at least 600° C. while agitating the fly ash in the presence of oxygen; and
(c) terminating exposure of said fly ash to said microwave radiation when the carbon content of the fly ash has fallen below a predetermined level.

2. The method of claim 1 wherein the microwave reactor is a fluidized bed vessel.

3. The method of claim 1 further including a system for monitoring the temperature of said fly ash.

4. The method of claim 1 carried out without the addition of auxiliary fuel.

5. The method of claim 1 wherein the fly ash has a carbon content of at least 3% by weight.

6. The method of claim 1 wherein the microwave radiation has a frequency between 300 MHz and 3000 MHz.

7. The method of claim 1 wherein a microwave radiation power level and process duration time are employed which are sufficient to produce a specific energy in the fly ash of between 2 kW-h/t and 25 kW-h/t.

8. The method of claim 1 wherein a microwave radiation power level and process duration time are employed which are sufficient to produce a specific energy in the fly ash of between 5 kW-h/t and 10 kW-h/t.

9. The method of claim 1 wherein the fly ash has a size in excess of 106 microns.

10. The method of claim 1 wherein the exposure of said fly ash to said microwave radiation is terminated when the temperature of the fly ash falls below 600° C.

11. The method claim 1 wherein the predetermined level is 3% carbon by weight.

12. The method of claim I wherein the microwave reactor further includes a material feed system to introduce fresh fly ash and a removal system to remove treated fly ash.

13. The method of claim 12 wherein the material feed system is adapted to introduce fresh fly ash into the microwave reactor when the carbon content of the treated fly ash falls below a predetermined level.

14. The method of claim 1 wherein the microwave reactor further includes a material feed system to continuously introduce fresh fly ash and a removal system to continuously remove treated fly ash, in which the fly ash within the microwave reactor is maintained at a temperature in the range 800° C.-850° C. and specific microwave energy in the range 5-10 kW-h/t is imparted to it.

15. A method of reducing carbon levels and ammonia levels in fly ash containing ammonia comprising:
(a) exposing the fly ash to microwave radiation in the presence of carbon-free material so as to raise its temperature to at least 600° C. while agitating the fly ash in the presence of oxygen; and
(b) terminating exposure of said fly ash to said microwave radiation when the carbon content of the fly ash has fallen below a predetermined level.

16. The method of claim 16 wherein the microwave reactor is fluidized bed vessel.

17. The method of claim 16 further including a system for monitoring the temperature of said fly ash.

18. The method of claim 16 carried out without the addition of auxiliary fuel.
